(19) United States
(12) Patent Application Publication
(10) Pub. No.: US 2011/0051015 A1
(43) Pub. Date: Mar. 3, 2011

(54) TELEVISION SIGNAL RECEIVING TUNER

(76) Inventor: Kazuma Kobashi, Miyagi-ken (JP)

(21) Appl. No.: 12/868,478

(22) Filed: Aug. 25, 2010

(30) Foreign Application Priority Data
Aug. 25, 2009 (JP) 2009-194359

(51) Int. Cl. H04N 5/50

(52) U.S. Cl. 348/731; 348/E05.097

(57) ABSTRACT

A television signal receiving tuner includes a mixer circuit configured to convert a frequency signal of a reception channel regarding a digital television signal or an analog television signal into an intermediate frequency signal, a first intermediate frequency amplifying circuit connected to a rear stage of the mixer circuit, a trap circuit connected between any one of an output terminal of the mixer circuit and an input terminal of the first intermediate frequency amplifying circuit and a ground, and attenuating a frequency band, which is adjacent to the intermediate frequency signal, on a basis of an attenuation point, and a tuned circuit connected between the output terminal of the mixer circuit and the input terminal of the first intermediate frequency amplifying circuit to tune the intermediate frequency signal by employing the attenuation point or a frequency band approximating to the attenuation point as a tuning point.

### CROSS REFERENCE TO RELATED APPLICATION

The present invention contains subject matter related to and claims priority to Japanese Patent Application JP 2009-194359 filed in the Japanese Patent Office on Aug. 25, 2009, the entire content of which is incorporated herein by reference.

### BACKGROUND

1. Technical Field

The present disclosure relates to a television signal receiving tuner. More particularly, the present disclosure relates to a television signal receiving tuner available for a tuner that receives a digital television signal and an analog television signal.

2. Related Art

As shown in FIG. 11, as one example, an existing television signal receiving tuner 101 mainly includes a mixer circuit 103, a trap circuit 105 and a first intermediate frequency amplifying circuit 104.

The mixer circuit 103 is provided inside a chip IC 102 to convert a frequency signal of a reception channel regarding a digital television signal or an analog television signal into an intermediate frequency signal. A second intermediate frequency amplifying circuit 108 is connected to an output terminal of the mixer circuit 103 to amplify the intermediate frequency signal output from the mixer circuit 103.

The trap circuit 105 is provided outside the chip IC 102 and is connected between the mixer circuit 103 and the first intermediate frequency amplifying circuit 104 to attenuate a frequency band adjacent to an intermediate frequency signal based on an analog television signal to be received. At the time of receiving the digital television signal, the function of the trap circuit 105 is invalidated by the conduction of a switching element 107 connected in parallel to the trap circuit 105.

The first intermediate frequency amplifying circuit 104 is provided inside the chip IC 102, and for example is a gain control amplifier. Further, the first intermediate frequency amplifying circuit 104 is connected to the rear stage of the trap circuit 105. A third intermediate frequency amplifying circuit 109 is connected between the trap circuit 105 and the first intermediate frequency amplifying circuit 104. When the third intermediate frequency amplifying circuit 109 individually outputs respective intermediate frequency signals based on the digital television signal and the analog television signal, the intermediate frequency signal based on the analog television signal is output to an AIF 114. The intermediate frequency signal based on the digital television signal input to the first intermediate frequency amplifying circuit 104 through a SAW filter 113 is further amplified together with a control signal received from an IF-AGC (an intermediate-frequency automatic gain control circuit) through an AGC terminal 115, and then is output to DIFs 116 and 117.

Furthermore, in the existing television signal receiving tuner 101, since a digital and analog integrated demodulation IC is used, both the digital television signal and the analog television signal may be extracted from the DIFs 116 and 117. Japanese Unexamined Patent Application Publication No. 2001-157128 is an example of the related art.

However, in the existing television signal receiving tuner 101, when both the trap circuit 105 and the first intermediate frequency amplifying circuit 104 effectively operate, since impedance changes suddenly due to the characteristics of the trap circuit 105 that attenuates a narrow band, a high frequency signal generated at the time of the output of the first intermediate frequency amplifying circuit 104 serves as an unnecessary noise source, so that ripples (wave-like undulation occurring in signals) and parasitic oscillation of the first intermediate frequency amplifying circuit 104 may occur with respect to signals output from the DIFs 116 and 117.

Hereinafter, the above phenomena will be described in detail. When the frequency of the intermediate frequency signal passing through the trap circuit 105 is outside a resonant frequency of the trap circuit 105, since the trap circuit 105 is low impedance, the trap circuit 105 is in a pass-through state as surrounded by a dot line of FIG. 12, so that the intermediate frequency signal may pass through the trap circuit 105 as shown in FIG. 12.

On the other hand, when the frequency of the intermediate frequency signal passing through the trap circuit 105 is equal to or approximates to the resonant frequency of the trap circuit 105, since the trap circuit 105 is high impedance, the trap circuit 105 is in an open state as surrounded by a dot line of FIG. 13, so that the intermediate frequency signal may not theoretically pass through the trap circuit 105 as shown in FIG. 13. Further, when a weak electric field is applied to the first intermediate frequency amplifying circuit 104, since gain of the first intermediate frequency amplifying circuit 104 is maximized, high frequency noise N may be generated in the trap circuit 105 from a conductive line between an output terminal of the first intermediate frequency amplifying circuit 104 and the DIFs 116 and 117. As a result, intrusion of the high frequency noise N discharged from the trap circuit 105 in the open state occurs and unnecessary returning occurs between the input and output of the first intermediate frequency amplifying circuit 104. Thus, as described above, the high frequency signal generated at the time of the output of the first intermediate frequency amplifying circuit 104 serves as the unnecessary noise source, so that the ripples and the parasitic oscillation of the first intermediate frequency amplifying circuit 104 may occur with respect to signals output from the DIFs 116 and 117 as shown in FIG. 14.

Consequently, in the existing television signal receiving tuner 101, since the above problems occur when using the first intermediate frequency amplifying circuit 104 while the trap circuit 105 is operating, it may be impossible to use the trap circuit 105 at the time of receiving an analog television signal, so that it may not be possible to satisfy required analog reception characteristics.

### SUMMARY

According to a first aspect of the invention, there is provided a television signal receiving tuner including: a mixer circuit configured to convert a frequency signal of a reception channel regarding a digital television signal or an analog television signal into an intermediate frequency signal; a first intermediate frequency amplifying circuit connected to a rear stage of the mixer circuit; a trap circuit connected between any one of an output terminal of the mixer circuit and an input terminal of the first intermediate frequency amplifying circuit and a ground, and configured to attenuate a frequency band, which is adjacent to the intermediate frequency signal based on the analog television signal, on a basis of an attenuation point; and a tuned circuit connected between the output terminal of the mixer circuit and the input terminal of the first intermediate frequency amplifying circuit to tune the intermediate frequency signal by employing the attenuation point or a frequency band approximating to the attenuation point as a tuning point.

### BRIEF DESCRIPTION OF THE DRAWINGS

FIG. 1 is a circuit diagram illustrating a television signal receiving tuner according to an embodiment of the invention.

FIG. 2 is a circuit diagram illustrating a tuned circuit and a trap circuit according to an embodiment and a graph illustrating frequency characteristics thereof.

FIG. 3 is a circuit diagram illustrating a case in which a frequency of an intermediate frequency signal passing through a trap circuit is outside an attenuation point in a television signal receiving tuner according to an embodiment.

FIG. 4 is a circuit diagram illustrating a case in which a frequency of an intermediate frequency signal passing through a trap circuit is equal to an attenuation point in a television signal receiving tuner according to an embodiment.

FIG. 5 is a graph illustrating wide frequency characteristics in a television signal receiving tuner according to an embodiment.

FIG. 6 is a circuit diagram illustrating a state in which a switching element is in a conductive state in a tuned circuit and a trap circuit according to an embodiment.

FIG. 7 is a graph illustrating frequency characteristics of a digital television signal in a television signal receiving tuner according to an embodiment.

FIG. 8 is a graph illustrating frequency characteristics of an analog television signal and a digital television signal in a television signal receiving tuner according to an embodiment.

FIG. 9 is a graph locally illustrating frequency characteristics of a digital television signal in a television signal receiving tuner according to an embodiment.

FIG. 10 is a circuit diagram illustrating one example of a television signal receiving tuner according to another embodiment of the invention.

FIG. 11 is a circuit diagram illustrating one example of an existing television signal receiving tuner.

FIG. 12 is a circuit diagram illustrating a case in which a frequency of an intermediate frequency signal passing through a trap circuit is outside an attenuation point in an existing television signal receiving tuner.

FIG. 13 is a circuit diagram illustrating a case in which a frequency of an intermediate frequency signal passing through a trap circuit is equal to an attenuation point in an existing television signal receiving tuner.

FIG. 14 is a graph illustrating wide frequency characteristics in an existing television signal receiving tuner.

### DESCRIPTION OF EXEMPLARY EMBODIMENTS

Hereinafter, an embodiment of a television signal receiving tuner in accordance with the invention will be described.

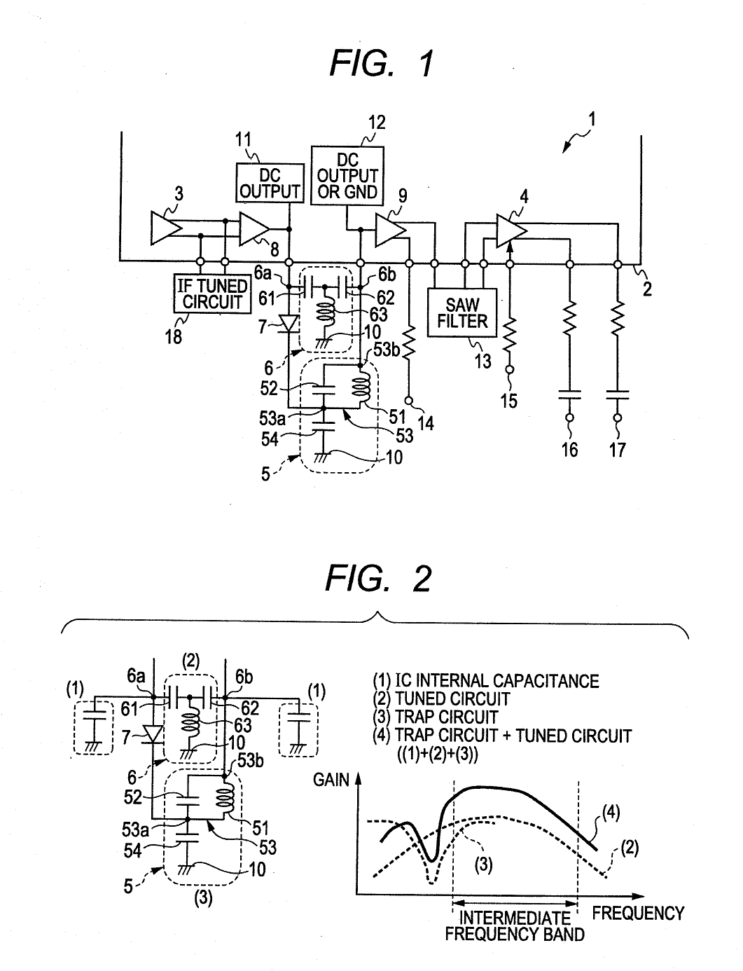

As shown in FIG. 1, the television signal receiving tuner 1 according to the present embodiment includes a mixer circuit 3, a first intermediate frequency amplifying circuit 4, a trap circuit 5 and a tuned circuit 6. Preferably, the television signal receiving tuner 1 according to the embodiment further includes two second intermediate frequency amplifying circuits 8 and 9, and a SAW filter 13. In addition, the mixer circuit 3, the first intermediate frequency amplifying circuit 4, and the second intermediate frequency amplifying circuits 8 and 9 are provided inside a tuner IC 2, and other circuits including the trap circuit 5, the tuned circuit 6 and the SAW filter 13 are provided outside the tuner IC 2.

The mixer circuit 3 converts a frequency signal of a reception channel regarding a digital television signal and an analog television signal into an intermediate frequency signal. When the second intermediate frequency amplifying circuit 8 is connected between the mixer circuit 3 and the tuned circuit 6, it is preferable that another intermediate frequency amplifying circuit 18 provided outside the tuner IC 2 is connected between the second intermediate frequency amplifying circuit 8 and the mixer circuit 3.

The first intermediate frequency amplifying circuit 4 is connected to the rear stage of the mixer circuit 3 through at least the trap circuit 5 and the tuned circuit 6, preferably, the two second intermediate frequency amplifying circuits 8 and 9 and the SAW filter 13. Furthermore, two DIFs 16 and 17 are connected to an output terminal of the first intermediate frequency amplifying circuit 4 to output an intermediate frequency signal based on the digital television signal. Preferably, the first intermediate frequency amplifying circuit 4 is a gain control amplifier. In such a case, preferably, an IF-AGC (an intermediate-frequency automatic gain control circuit) provided outside the tuner IC 2 is connected to the first intermediate frequency amplifying circuit 4 through an AGC terminal 15.

The trap circuit 5 attenuates a frequency band, which is adjacent to an intermediate frequency signal based on an analog television signal, on the basis of an attenuation point. In the trap circuit 5 according to the embodiment, the attenuation point is set to a frequency of a low frequency side or a frequency, which is lower than the frequency of the low frequency side, in a frequency band based on a required intermediate frequency signal. In this regard, the trap circuit 5 is connected between an input terminal of the first intermediate frequency amplifying circuit 4 and a ground 10.

Preferably, the trap circuit 5 is configured such that a trap function thereof is validated at the time of receiving the analog television signal and the trap function thereof is invalidated at the time of receiving the digital television signal. As one example of such a trap circuit 5, preferably, the trap circuit 5 according to the embodiment includes a parallel connection circuit 53 and a second capacitor 54. The parallel connection circuit 53 includes a first inductor 51 and a first capacitor 52 connected in parallel to each other, and the second capacitor 54 is serially connected between one end 53a of the parallel connection circuit 53 and the ground 10. The one end 53a of the parallel connection circuit 53 is connected to an input terminal 6a of the tuned circuit 6 through a switching element 7. Furthermore, the other end 53b of the parallel connection circuit 53 is connected to an output terminal 6b of the tuned circuit 6.

The switching element 7 connected to the trap circuit 5 according to the embodiment is in a conductive state only at the time of receiving the digital television signal. For example, when the switching element 7 is a diode, a circuit 11 that performs DC output is provided at an anode side of the switching element 7 and a circuit 12 including any one of DC output and the ground is provided at the other end 53b of the parallel connection circuit 53, so that the switching element 7 is formed.

The tuned circuit 6 tunes the intermediate frequency signal by employing the attenuation point of the trap circuit 5 or a frequency band approximating to the attenuation point as a tuning point. In the tuned circuit 6 according to the embodiment, the tuning point is set to be a frequency higher than the attenuation point of the trap circuit 5 and exist in a low frequency side of the frequency band based on the required intermediate frequency signal. The tuned circuit 6 is connected between an output terminal of the mixer circuit 3 and the input terminal of the first intermediate frequency amplifying circuit 4. Furthermore, an AIF 14 that outputs an intermediate frequency signal based on the analog television signal is connected to the output terminal 6b of the tuned circuit 6 through the second intermediate frequency amplifying circuit 9 or is directly connected to the output terminal 6b of the tuned circuit 6 when the second intermediate frequency amplifying circuit 9 is not connected.

Preferably, the tuned circuit 6 according to the embodiment, for example, includes a third capacitor 61, a fourth capacitor 62 and a second inductor 63. In such a case, the third capacitor 61 and the fourth capacitor 62 are serially connected between the input terminal 6a and the output terminal 6b of the tuned circuit 6, and the second inductor 63 is serially connected between a connection point between the third capacitor 61 and the fourth capacitor 62 and the ground 10.

According to the embodiment, preferably, the two second intermediate frequency amplifying circuits 8 and 9 are used. Preferably, the second intermediate frequency amplifying circuit 8 is connected between the mixer circuit 3 and the tuned circuit 6, and the second intermediate frequency amplifying circuit 9 is connected between the tuned circuit 6 and the first intermediate frequency amplifying circuit 4. However, the second intermediate frequency amplifying circuit 8 or 9 may be connected only to any one of between the mixer circuit 3 and the tuned circuit 6 and between the tuned circuit 6 and the first intermediate frequency amplifying circuit 4.

Preferably, the SAW filter 13 is connected between the second intermediate frequency amplifying circuit 9, which is provided at the rear stage of the tuned circuit 6, and the first intermediate frequency amplifying circuit 4. However, when the second intermediate frequency amplifying circuit 9 is not provided in the television signal receiving tuner 1 according to the embodiment, the SAW filter 13 is preferably connected between the tuned circuit 6 and the first intermediate frequency amplifying circuit 4.

Next, the operation of the television signal receiving tuner 1 according to the embodiment will be described.

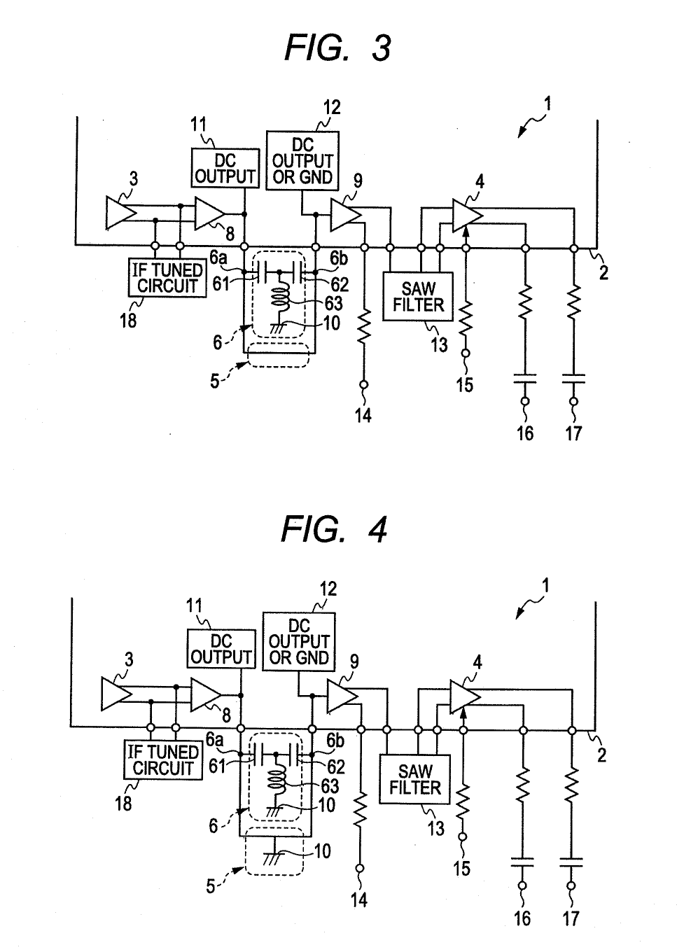

In the television signal receiving tuner 1 according to the embodiment, as shown in FIGS. 1 and 2, the tuned circuit 6 and the trap circuit 5 are connected between the mixer circuit 3 and the first intermediate frequency amplifying circuit 4. Furthermore, the trap circuit 5 is connected between the input terminal of the first intermediate frequency amplifying circuit 4 and the ground 10 through the tuned circuit 6. Thus, in the case of frequencies other than the resonant frequency (attenuation point) of the trap circuit 5, since the trap circuit 5 is low impedance, the trap circuit 5 is in a pass-through state as surrounded by a dot line of FIG. 3, so that the intermediate frequency signal can pass through the trap circuit 5 as shown in FIG. 3. On the other hand, when the frequency of the intermediate frequency signal passing through the trap circuit 5 is equal to or approximates to the resonant frequency (attenuation point) of the trap circuit 5, since the trap circuit 5 is high impedance, the trap circuit 5 is in a ground state as surrounded by a dot line of FIG. 4, so that the intermediate frequency signal flows to the ground 10 connected to the trap circuit 5 as shown in FIG. 4.

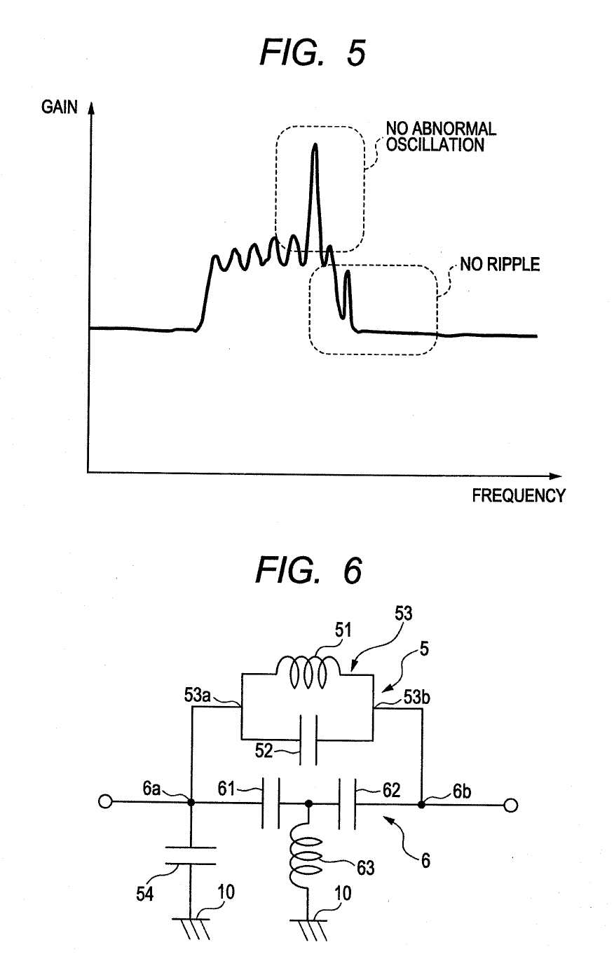

As described above, in the television signal receiving tuner 1, since one end of the trap circuit 5 is grounded, a signal line including the trap circuit 5 can be prevented from serving as an antenna at the resonant point of the trap circuit 5. As a result, as shown in FIG. 5, the occurrence of unnecessary returning and ripple can be avoided in the first intermediate frequency amplifying circuit 4 provided at the rear stage of the trap circuit 5. Moreover, when a gain control amplifier is used as the first intermediate frequency amplifying circuit 4, since there is no need for concern about the unnecessary returning and ripples, gain adjustment of the intermediate frequency signal can be easily performed and gain of the intermediate frequency signal based on the digital television signal can be increased.

In addition, in the television signal receiving tuner 1 according to the embodiment, the tuning point of the tuned circuit 6 is set to be equal to or approximate to the attenuation point of the trap circuit 5. According to the embodiment, the attenuation point of the trap circuit 5 is set to a frequency lower than a frequency of a low frequency side in a frequency band based on the required intermediate frequency signal as indicated by a dotted line (3) in the graph at the right side of FIG. 2. The tuning point of the tuned circuit 6 is set to a frequency higher than the attenuation point of the trap circuit 5 and exist in the low frequency side in the frequency band based on the required intermediate frequency signal as indicated by a dotted line (2) in the graph at the right side of FIG. 2. As a result, as indicated by a solid line (4) in the graph at the right side of FIG. 2, gain of the intermediate frequency signal based on the analog television signal, which has passed through the tuned circuit 6 and the trap circuit 5 and has been excessively attenuated by the trap circuit 5, can be rapidly increased in the required intermediate frequency band.

That is, one end of the trap circuit 5 according to the embodiment is grounded, and reduction of the gain of the intermediate frequency band caused by the attenuation characteristics of the trap circuit 5 is compensated by the tuned circuit 6, so that the digital television signal and the analog television signal can be received and required analog characteristics can be achieved at the time of receiving the analog television signal.

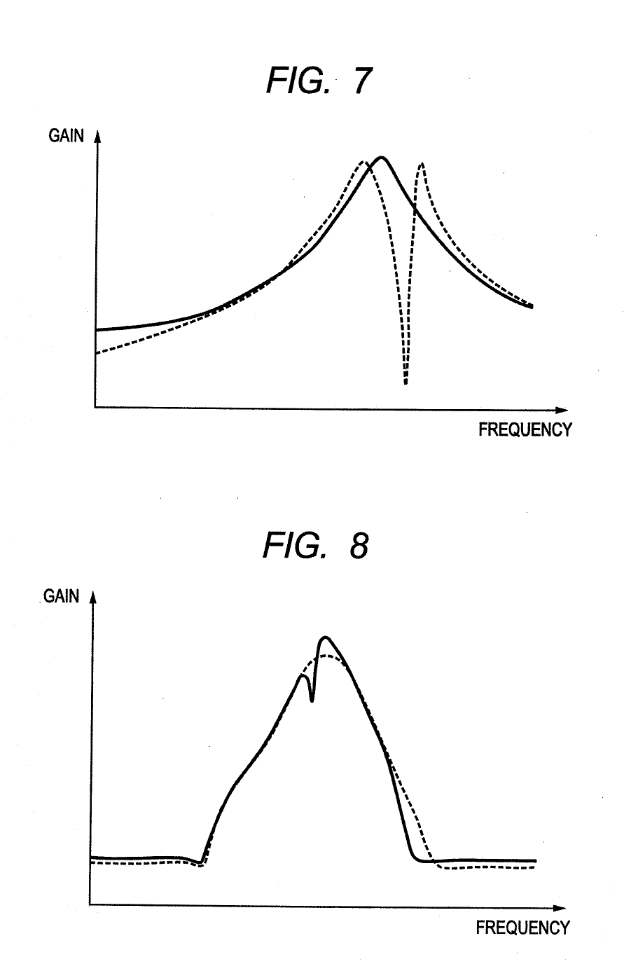

Moreover, in the trap circuit 5 according to the embodiment, the trap function of the trap circuit 5 is validated at the time of receiving the analog television signal and is invalidated at the time of receiving the digital television signal. In detail, as shown in FIG. 1, the switching element 7 connected to the trap circuit 5 according to the embodiment is in the conductive state only at the time of receiving the digital television signal, so that the presence or absence of the operation of the trap circuit 5 can be determined according to the type of signals. For example, when the switching element 7 is in the conductive state, since the tuned circuit 6 and the trap circuit 5 form an equivalent circuit as shown in FIG. 6, the frequency characteristics thereof are changed from characteristics indicated by a dotted line to characteristics indicated by a solid line as shown in FIG. 7. As described above, in the television signal receiving tuner 1 according to the embodiment, the intermediate frequency signal based on the weak output digital television signal can be prevented from being attenuated by the trap circuit 5.

That is, at the time of receiving the analog television signal, the switching element 7 is allowed to be in a non-conductive state, so that frequency characteristics including a trap operation as indicated by a solid line of FIG. 8 can be achieved. At the time of receiving the digital television signal, the switching element 7 is allowed to be in a conductive state, so that frequency characteristics excluding the trap operation as indicated by a dotted line of FIG. 8 can be achieved.

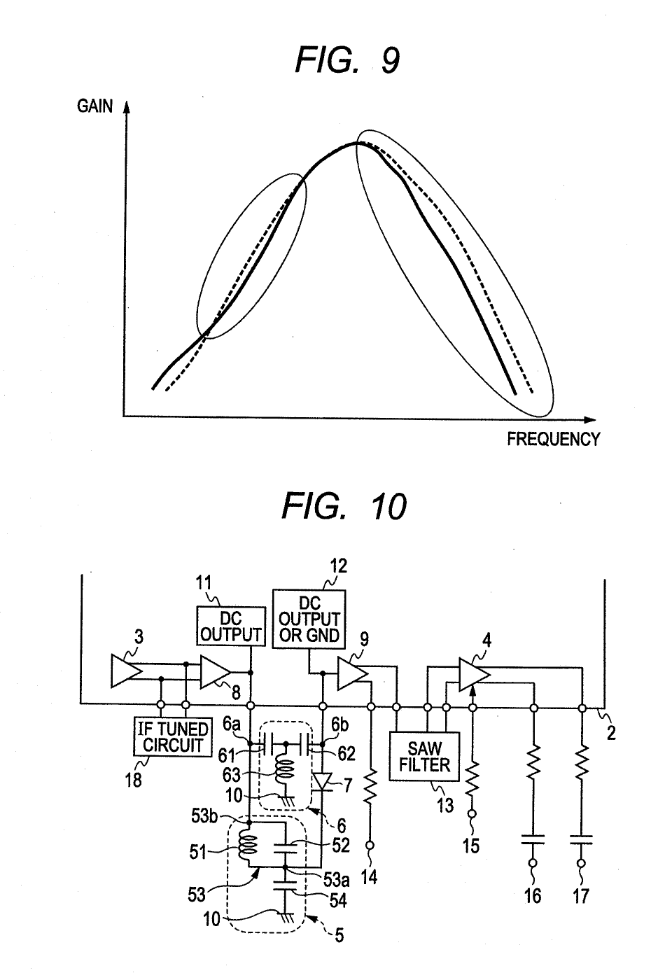

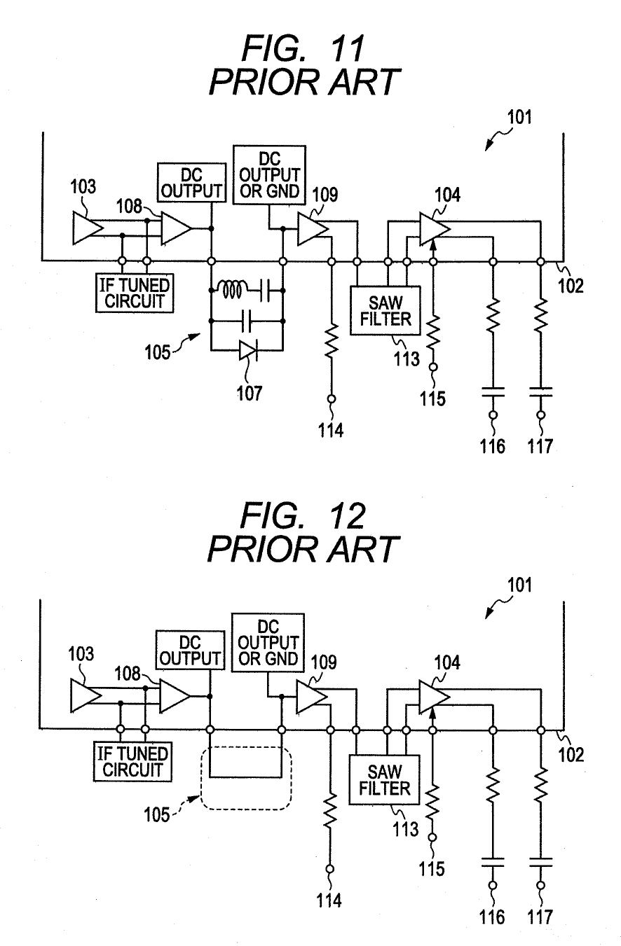

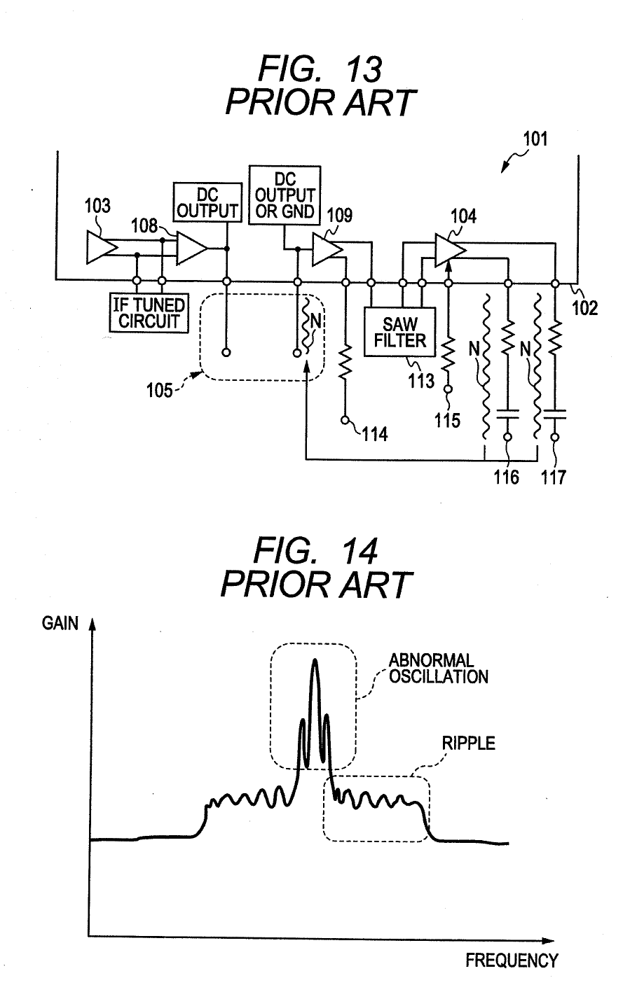

Furthermore, a dotted line of FIG. 9 represents band characteristics of the existing television signal receiving tuner 101 and a solid line of FIG. 9 represents band characteristics of the television signal receiving tuner 1 according to the embodiment. When a diode is selected as the switching element 7 and is allowed to be in a conductive state, as compared with the existing television signal receiving tuner 101, the band of the digital television signal can be limited by the diode, so that only the required intermediate frequency band can be easily achieved as shown in FIG. 9.

In addition, in the trap circuit 5 according to the embodiment, as shown in FIG. 1, the parallel connection circuit 53, the second capacitor 54 and the ground 10 are serially connected to one another. The input terminal 6a of the tuned circuit 6 is connected to the one end 53a of the parallel connection circuit 53 through the switching element 7, and the output terminal 6b of the tuned circuit 6 is connected to the other end 53b of the parallel connection circuit 53. That is, with a simple configuration, the trap circuit 5 suitable for the television signal receiving tuner 1 according to the embodiment can be formed.

Meanwhile, in the tuned circuit 6 according to the embodiment, as shown in FIG. 1, the second inductor 63 is serially connected between the connection point between the third capacitor 61 and the fourth capacitor 62, which are serially connected to each other, and the ground 10. This is because the one end 53a and the other end 53b of the parallel connection circuit 53 in the trap circuit 5 are connected to the input terminal 6a and the output terminal 6b of the tuned circuit 6, respectively. That is, with a simple configuration, the tuned circuit 6 suitable for the television signal receiving tuner 1 according to the embodiment can be formed.

Moreover, since the television signal receiving tuner 1 according to the embodiment includes the two second intermediate frequency amplifying circuits 8 and 9, the gain of the intermediate frequency signal can be easily increased. Furthermore, since the television signal receiving tuner 1 according to the embodiment includes the SAW filter 13, the intermediate frequency signal based on the digital television signal can be easily selected and extracted from the signal output from the circuit provided at the rear stage of the tuned circuit 6.

That is, according to the television signal receiving tuner 1 of the embodiment, the mixer circuit 3 converts the digital television signal and the analog television signal into the intermediate frequency signal, and the signal line including the trap circuit 5 is prevented from serving as an antenna at the resonant point of the trap circuit 5 provided at the rear stage of the mixer circuit 3, so that the occurrence of unnecessary returning can be avoided in the first intermediate frequency amplifying circuit 4 provided at the rear stage of the trap circuit 5. Furthermore, the intermediate frequency signal based on the analog television signal, which has been attenuated by the trap circuit 5, is tuned by the tuned circuit 6, so that the gain of the intermediate frequency signal can be rapidly increased. As a result, the digital television signal and the analog television signal can be received and required analog characteristics can be achieved at the time of receiving the analog television signal.

In addition, the present disclosure is not limited to the above-described embodiment. That is, various modifications can be made if necessary.

For example, according to another embodiment, as shown in FIG. 10, the trap circuit 5 may be connected between the output terminal of the mixer circuit 3 and the ground 10. In such a case, the one end 53a of the parallel connection circuit 53 of the trap circuit 5 is connected to the output terminal 6b of the tuned circuit 6 through the switching element 7, and the other end 53b thereof is connected to the input terminal 6a of the tuned circuit 6.

Furthermore, according to the previous embodiment, the tuned circuit 6 is provided in order to improve the analog reception characteristics. However, only for the purpose of preventing oscillation of the first intermediate frequency amplifying circuit 4 and the like, the tuned circuit 6 may be removed from the television signal receiving tuner 1 according to the embodiment.

It should be understood by those skilled in the art that various modifications, combinations, sub-combinations and alterations may occur depending on design requirements and other factors insofar as they are within the scope of the appended claims or the equivalents thereof.

What is claimed is:

1. A television signal receiving tuner comprising:
a mixer circuit configured to convert a frequency signal of a reception channel regarding a digital television signal or an analog television signal into an intermediate frequency signal;
a first intermediate frequency amplifying circuit connected to a rear stage of the mixer circuit;
a trap circuit connected between any one of an output terminal of the mixer circuit and an input terminal of the first intermediate frequency amplifying circuit and a ground, and configured to attenuate a frequency band, which is adjacent to the intermediate frequency signal based on the analog television signal, on a basis of an attenuation point; and
a tuned circuit connected between the output terminal of the mixer circuit and the input terminal of the first intermediate frequency amplifying circuit to tune the intermediate frequency signal by employing the attenuation point or a frequency band approximating to the attenuation point as a tuning point.

2. The television signal receiving tuner according to claim 1, wherein a trap function of the trap circuit is validated at a time of receiving the analog television signal and is invalidated at a time of receiving the digital television signal.

3. The television signal receiving tuner according to claim 1, wherein the trap circuit includes:
a parallel connection circuit including a first inductor and a first capacitor connected in parallel to each other; and
a second capacitor connected serially between one end of the parallel connection circuit and the ground,
wherein the one end of the parallel connection circuit is connected to one of an input terminal and an output terminal of the tuned circuit through a switching element being in a conductive state only at a time of receiving the digital television signal, and
the other end of the parallel connection circuit is connected to a remaining one of the input terminal and the output terminal of the tuned circuit.

4. The television signal receiving tuner according to claim 3, wherein the tuned circuit includes:
a third capacitor and a fourth capacitor serially connected between an input terminal and an output terminal of the tuned circuit; and
a second inductor serially connected between a connection point between the third capacitor and the fourth capacitor, and the ground.

5. The television signal receiving tuner according to claim 1, wherein the first intermediate frequency amplifying circuit comprises a gain control amplifier.

6. The television signal receiving tuner according to claim 1, further comprising at least one second intermediate frequency amplifying circuits connected to any one of between the mixer circuit and the tuned circuit, and between the tuned circuit and the first intermediate frequency amplifying circuit, or connected to both of between the mixer circuit and the tuned circuit, and between the tuned circuit and the first intermediate frequency amplifying circuit, respectively.

7. The television signal receiving tuner according to claim 1, further comprising a SAW filter connected between the tuned circuit or a second intermediate frequency amplifying circuit and the first intermediate frequency amplifying circuit.
